(19) United States
(12) Patent Application Publication
(10) Pub. No.: US 2017/0001277 A1
(43) Pub. Date: Jan. 5, 2017

(54) MACHINE TOOL CAPABLE OF REDUCING THERMAL ERROR

(71) Applicant: NATIONAL CHUNG HSING UNIVERSITY, Taichung City (TW)

(72) Inventors: Ming-Tsang LEE, Taipei City (TW); Jenq-Shyong CHEN, Taichung City (TW); Chih-Cherng HO, Taichung City (TW); Ming-Chieh HUNG, Changhua County (TW)

(21) Appl. No.: 15/178,300

(22) Filed: Jun. 9, 2016

(30) Foreign Application Priority Data
Jun. 30, 2015 (TW) 104121088

(51) Int. Cl. B23Q 11/00; B23Q 11/12; B23Q 11/14

(52) U.S. Cl. CPC B23Q 11/0003; B23Q 11/143; B23Q 11/128

(57) ABSTRACT

A machine tool includes a table, a main shaft, and an electric heating piece. The table includes an upright post and a main shaft support element connected to the upright post. The main shaft is rotatably disposed at the main shaft support element of the table. The electric heating piece is disposed at the main shaft support element of the table and positioned on a side of the main shaft, wherein the side of the main shaft manifests a lower thermal deformation level. The regulation of the electric heating piece minimizes the nonlinear thermal deformation of the main shaft, thereby enhancing processing precision.

### BACKGROUND OF THE INVENTION

1. Technical Field

The present invention relates to machine tools and, more particularly, to a machine tool capable of reducing thermal errors.

2. Description of Related Art

A motor drives a main shaft of a machine tool to rotate at a high speed while the machine tool is operating. Much heat is generated from the machine tool, as the main shaft undergoes high-speed rotation. Unless an appropriate heat dissipation mechanism is available, the main shaft will be likely to deform because of uneven distribution of ambient temperature. The deformation of the main shaft renders the processing precision difficult to correct.

The related prior art involves providing a channel to a table such that a main shaft undergoes heat dissipation with a cooling fluid inside the channel. Nonetheless, the circulation of the cooling fluid is accompanied by a gradual increase in the temperature of the cooling fluid, thereby dwindling the difference in temperature between the cooling fluid and the main shaft and thus deteriorating the cooling efficiency. To improve the heat dissipation of the cooling fluid, China patent CN202106241 and China patent CN202129679 are directed to a heat dissipation technique for controlling the temperature of a main shaft through thermoelectric conversion characteristics of a cooling chip. Unfortunately, the cooling chip is disadvantageously ineffective in minimizing the thermal deformation of the main shaft. To overcome the disadvantage, both China patent CN202106241 and China patent CN202129679 disclose that the cooling chip operates in conjunction with a cooling fluid such that the cooling chip removes the heat previously taken up by the cooling fluid. Unfortunately, the table must come with the cooling chip and a cooling channel and requires a related apparatus which pressurizes the cooling fluid, and in consequence China patent CN202106241 and China patent CN202129679 have drawbacks follows: exacerbation of structural complexity, high manufacturing cost, and failure of the cooling chip and the cooling fluid to optimize the heat dissipation of the main shaft.

### BRIEF SUMMARY OF THE INVENTION

It is an objective of the present invention to provide a machine tool capable of reducing thermal errors and thus minimizing the thermal deformation of a main shaft without augmenting structural complexity, so as to enhance processing precision and cut manufacturing cost.

In order to achieve the above and other objectives, the present invention provides a machine tool which comprises a table, a driving source, a main shaft, and an electric heating piece. The table comprises an upright post and a main shaft support element connected to the upright post. The driving source is disposed at the main shaft support element of the table. The main shaft is rotatably disposed at the main shaft support element of the table and connected to the driving source. The electric heating piece is disposed at the main shaft support element of the table and positioned on a side of the main shaft, wherein the side of the main shaft manifests a lower thermal deformation level, so as to serve a heating purpose. Hence, the machine tool of the present invention has an advantage as follows: due to the regulation of the electric heating piece, the nonlinear thermal deformation of the main shaft is minimized without altering the existing structure of the table, so as to enhance processing precision and cut manufacturing cost.

The detailed structures, features, assembly or use of the machine tool provided by the present invention are illustrated with embodiments and described below. However, persons skilled in the art understand that the description and exemplary specific embodiments of the present invention are illustrative of the present invention rather than restrictive of the claims of the present invention.

### BRIEF DESCRIPTION OF THE SEVERAL VIEWS OF THE DRAWINGS

FIG. 1 is a perspective view of a machine tool capable of reducing thermal errors according to the present invention;

FIG. 2 is another perspective view of the machine tool of the present invention;

FIG. 3 is a perspective view of the machine tool equipped with a top cover according to the present invention;

FIG. 4 is a top view of the machine tool of the present invention;

FIG. 5 is a bottom view of the machine tool of the present invention;

FIG. 6 is a schematic view of a probe for use with the machine tool of the present invention;

FIG. 7 is a schematic view of a coordinate system for use with the machine tool of the present invention, showing the relationship between the operating time and thermal deformation level of a main shaft before an electric heating piece and a cooling chip are turned on;

FIG. 8, which is similar to FIG. 7, shows the relationship between the operating time and thermal deformation level of a main shaft after the cooling chip has been turned on; and

FIG. 9, which is similar to FIG. 8, shows the relationship between the operating time and thermal deformation level of a main shaft after both the electric heating piece and the cooling chip have been turned on.

### DETAILED DESCRIPTION OF THE INVENTION

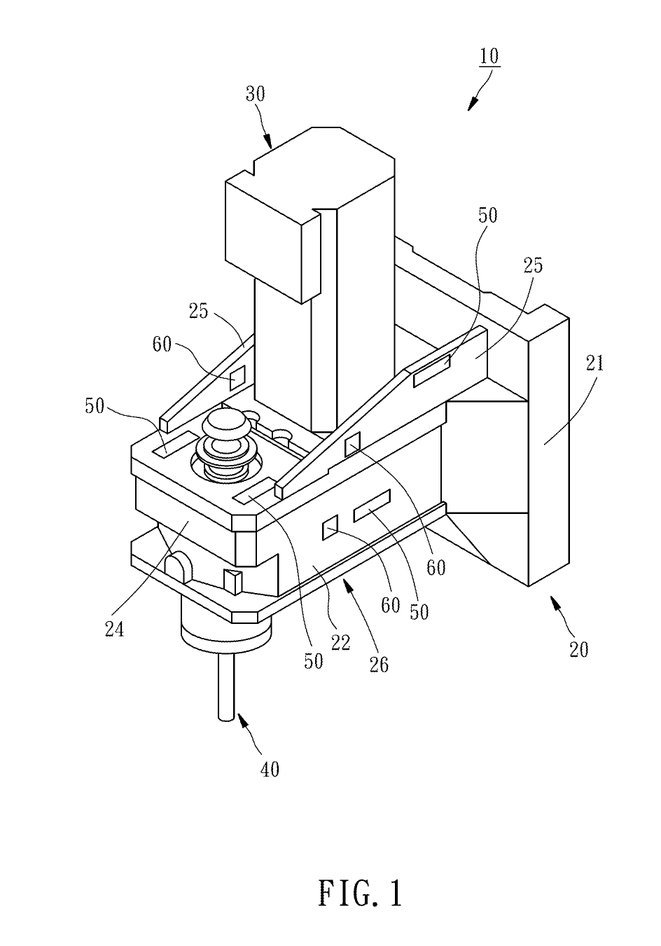

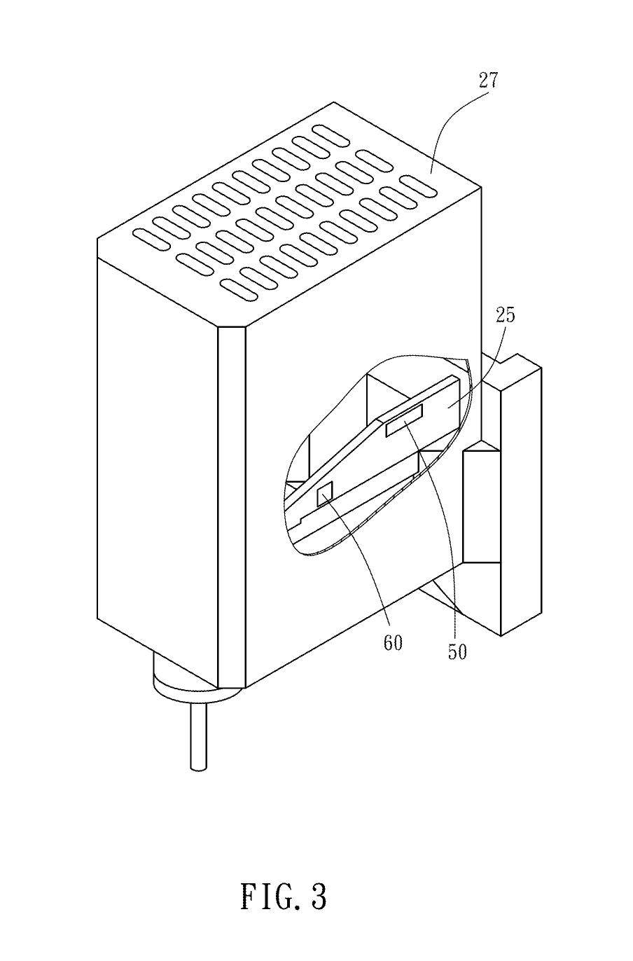

Referring to FIG. 1 through FIG. 4, a machine tool 10 of the present invention comprises a table 20, a driving source 30, a main shaft 40, and a plurality of electric heating pieces 50.

The table 20 comprises an upright post 21 and a main shaft support element 26. The main shaft support element 26 comprises a cantilever beam 22 and two opposing ribbed plates 25. The cantilever beam 22 comprises a fixed end 23 and a free end 24. The cantilever beam 22 is fixed to the front of the upright post 21 through the fixed end 23. The ribbed plates 25 are connected between the front of the upright post 21 and the top surface of the cantilever beam 22.

The driving source 30 is mounted on the cantilever beam 22 of the table 20 to exert a driving force.

The main shaft 40 is disposed at a free end 24 of the cantilever beam 22 of the table 20 and connected to the driving source 30 through a transmission belt (not shown); hence, the main shaft 40 is driven by the driving source 30 to rotate.

The electric heating pieces 50 are disposed on one side of the main shaft 40, wherein the side of the main shaft 40 manifests a lower thermal deformation level. The quantity of the electric heating pieces 50 is subject to changes, depending on the variation in the temperature of the table 20 while the main shaft 40 is rotating. In this embodiment, the electric heating pieces 50 are mounted at any of the three positions described below.

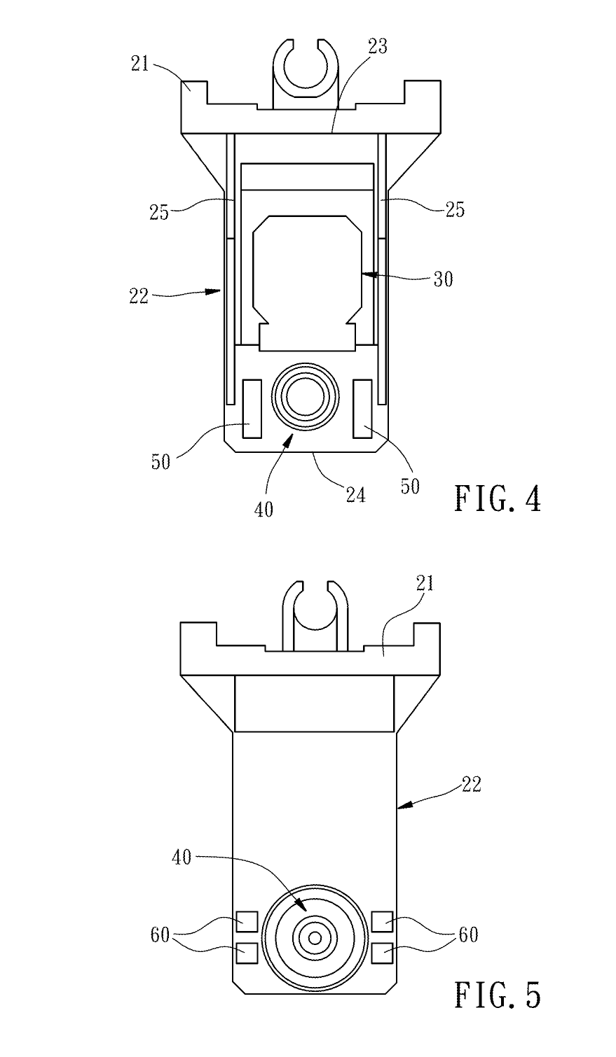

The electric heating pieces 50 may be mounted on the top surface of the free end 24 of the cantilever beam 22 of the main shaft support element 26. Referring to FIGS. 1 and 4, the electric heating pieces 50 are in the number of two, but the present invention is not limited thereto. The electric heating pieces 50 mounted on the top surface of the free end 24 of the cantilever beam 22 heat up the free end 24 of the cantilever beam 22 of the table 20 directly to thereby reduce the deformation which might otherwise occur to the main shaft 40 as a result of the variation in the temperature of the cantilever beam 22 of the table 20.

The electric heating pieces 50 may also be mounted on the top edge of the ribbed plates 25 of the main shaft support element 26, regardless of whether the electric heating pieces 50 are disposed on the inner sides or outer sides of the ribbed plates 25, and the electric heating pieces 50 are in the number of one, as shown in FIG. 1 through FIG. 3, for reasons described below. After a top cover 27 has been disposed on the table 20, the ribbed plates 25 take control of the deformation of the cantilever beam 22 in its entirety. Furthermore, due to the difference in their lengths, the tops edges and bottom edges of the ribbed plates 25 are heated up to different extents; hence, when heated up, the ribbed plates 25 cause the free end 24 of the cantilever beam 22 to bend, thereby leading to the thermal deformation of the main shaft 40. Therefore, when the electric heating pieces 50 are disposed on the top edges of the ribbed plates 25 of the main shaft support element 26, the tops edges and bottom edges of the ribbed plates 25 are heated up equally, thereby reducing the thermal deformation of the main shaft 40.

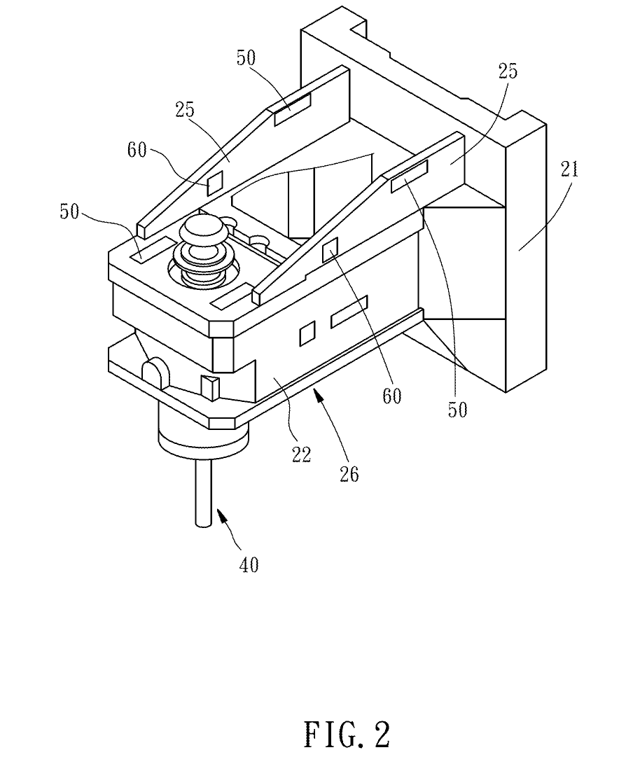

The electric heating pieces 50 may also be mounted on the left and right sides of the cantilever beam 22 of the main shaft support element 26, as shown in FIGS. 1 and 2, and provided in the number of two on the left and right sides of the cantilever beam 22, respectively. The electric heating pieces 50 heat up the left and right sides of the cantilever beam 22 to therefore prevent the main shaft 40 from undergoing thermal deformation associated with lateral sway.

To enhance the regulation efficiency, the present invention further provides a plurality of cooling chips 60. The cooling chips 60 are disposed on one side of the main shaft 40, wherein the side of the main shaft 40 manifests a higher thermal deformation level. In this embodiment, the cooling chips 60 are disposed on the bottom surface of the free end 24 of the cantilever beam 22 of the main shaft support element 26 as shown in FIG. 5, the bottom edges of the ribbed plates 25 of the main shaft support element 26 as shown in FIG. 1 through FIG. 3, and the left and right sides of the cantilever beam 22 of the main shaft support element 26 as shown in FIG. 1 through FIG. 3.

In practice, the left side, for example, of the cantilever beam 22 of the table 20 may be positioned proximate to any other mechanism, such as a tool magazine, and in consequence the electric heating pieces 50 and the cooling chips 60 cannot be smoothly disposed on the left side of the cantilever beam 22 because of the limited space between the table 20 and the aforesaid mechanism. In this situation, it is feasible to dispense with the electric heating pieces 50 and the cooling chips 60 on any side of the cantilever beam 22, then dispose the electric heating pieces 50 and the cooling chips 60 on the right side of the cantilever beam 22, and eventually turn on any one of the electric heating pieces 50 and the cooling chips 60 according to the extent of deformation of the cantilever beam 22, so as to regulate the main shaft 40. If an analysis and measurement show that the right side of the cantilever beam 22 surpasses the left side of the cantilever beam 22 in deformation level, it will be necessary to turn on the cooling chips 60 so as for the cooling chips 60 to cool down the right side of the cantilever beam 22. If the analysis and measurement show that the right side of the cantilever beam 22 is outstripped by the left side of the cantilever beam 22 in deformation level, it will be necessary to turn on the electric heating pieces 50 so as for the electric heating pieces 50 to heat up the right side of the cantilever beam 22. Hence, it is feasible to achieve uniform distribution of the variation of the temperature on the left and right sides of the cantilever beam 22.

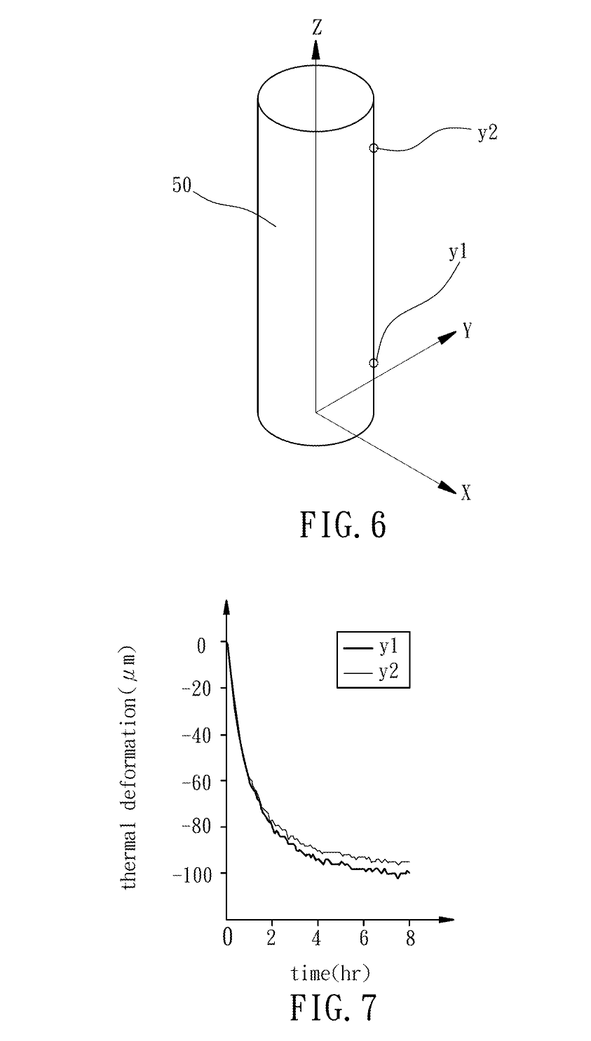

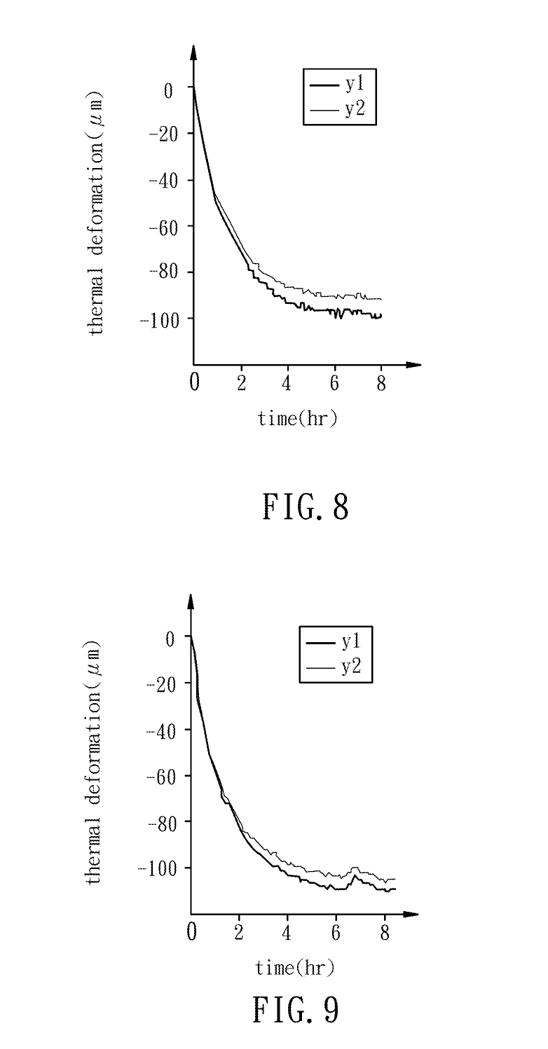

To measure the thermal deformation level of the main shaft 40, this embodiment entails performing a measurement operation with a contact-style cutter length gauge. Referring to FIG. 6, two main measurement points y1 and y2 of a probe 70 are defined, and then the probe 70 touches the main shaft 40 which is rotating at intervals to thereby obtain the coordinates of y1 and y2 and then subtract therefrom the initial coordinates of y1 and y2, so as to obtain the thermal deformation level of the main shaft 40. Referring to FIG. 7, before the electric heating pieces 50 and the cooling chips 60 are turned on, the shift of y1 in the negative direction of Y-axis is larger than the shift of y2 in the negative direction of Y-axis, indicating that the main shaft 40 undergoes backward deformation when operating at a high speed. Referring to FIG. 8, in the situation where only the cooling chips 60 are turned, there is no significant change between y1 and y2, and thus it is impossible to reduce the nonlinear deformation level of the main shaft 40. Referring to FIG. 9, after the electric heating pieces 50 and the cooling chips 60 have been turned, the positions of y1 and y2 relative to each other change gradually after the main shaft 40 has operated for 7 hours approximately, indicating that the thermal deformation angle of the main shaft 40 begins to improve. Finally, Table 1 below verifies that, under the same experimental condition, the thermal deformation of the main shaft 40 is effectively reduced after the electric heating pieces 50 and the cooling chips 60 have been turned on.

TABLE 1

| | y1(μm) | y2(μm) | \| y1 − y2 \| (μm) | θyz(10⁻³°) |
|---|---|---|---|---|
| Before being turned | −106.59 | −100.50 | 6.09 | 3.50 |
| After being turned | −108.66 | −104.50 | 4.16 | 2.38 |

In conclusion, the machine tool 10 of the present invention has an advantage as follows: due to the bidirectional regulation of the electric heating pieces 50 and the cooling chips 60, the nonlinear thermal deformation of the main shaft 40 is minimized without altering the existing structure of the table 20, so as to enhance processing precision and cut manufacturing cost.

What is claimed is:

1. A machine tool capable of reducing thermal errors, comprising:
a table including an upright post and a main shaft support element connected to the upright post;
a driving source disposed at the main shaft support element of the table;
a main shaft rotatably disposed at the main shaft support element of the table and connected to the driving source; and
at least an electric heating piece disposed at the main shaft support element of the table and positioned on a side of the main shaft, wherein the side of the main shaft manifests a lower thermal deformation level.

2. The machine tool capable of reducing thermal errors according to claim 1, wherein the main shaft support element includes a cantilever beam and two opposing ribbed plates, the cantilever beam including a fixed end and a free end and being connected to the upright post through the fixed end, the ribbed plates being connected between the upright post and a top surface of the cantilever beam, the main shaft being disposed at the free end of the cantilever beam, and the at least an electric heating piece being disposed on a top surface of the free end of the cantilever beam.

3. The machine tool capable of reducing thermal errors according to claim 1, wherein the main shaft support element includes a cantilever beam and two opposing ribbed plates, the cantilever beam including a fixed end and a free end and being connected to the upright post through the fixed end, the ribbed plates being connected between the upright post and a top surface of the cantilever beam, the main shaft being disposed at the free end of the cantilever beam, and the at least an electric heating piece being in a number of two and disposed on top edges of the ribbed plates, respectively.

4. The machine tool capable of reducing thermal errors according to claim 1, wherein the main shaft support element includes a cantilever beam and two opposing ribbed plates, the cantilever beam including a fixed end and a free end and being connected to the upright post through the fixed end, the ribbed plates being connected between the upright post and a top surface of the cantilever beam, the main shaft being disposed at the free end of the cantilever beam, and the at least an electric heating piece being disposed on one of a left side of the cantilever beam and a right side of the cantilever beam.

5. The machine tool capable of reducing thermal errors according to claim 1, wherein the main shaft support element includes a cantilever beam and two opposing ribbed plates, the cantilever beam including a fixed end and a free end and being connected to the upright post through the fixed end, the ribbed plates being connected between the upright post and a top surface of the cantilever beam, the main shaft being disposed at the free end of the cantilever beam, and the at least an electric heating piece being in a number of two and disposed on left and right sides of the cantilever beam, respectively.

6. The machine tool capable of reducing thermal errors of claim 1, further comprising at least a cooling chip disposed at the main shaft support element of the table and positioned on a side of the main shaft, wherein the side of the main shaft manifests a higher thermal deformation level.

7. The machine tool capable of reducing thermal errors according to claim 6, wherein the main shaft support element includes a cantilever beam and two opposing ribbed plates, the cantilever beam including a fixed end and a free end and being connected to the upright post through the fixed end, the ribbed plates being connected between the upright post and a top surface of the cantilever beam, the main shaft being disposed at the free end of the cantilever beam, the at least an electric heating piece being disposed on a top surface of the free end of the cantilever beam, and the cooling chip being disposed on a bottom surface of the free end of the cantilever beam.

8. The machine tool capable of reducing thermal errors according to claim 6, wherein the main shaft support element includes a cantilever beam and two opposing ribbed plates, the cantilever beam including a fixed end and a free end and being connected to the upright post through the fixed end, the ribbed plates being connected between the upright post and a top surface of the cantilever beam, the main shaft being disposed at the free end of the cantilever beam, the at least an electric heating piece being in a number of two and disposed on top edges of the ribbed plates, respectively, and the cooling chip being in a number of two and disposed on bottom edges of the ribbed plates, respectively.

9. The machine tool capable of reducing thermal errors according to claim 6, wherein the main shaft support element includes a cantilever beam and two opposing ribbed plates, the cantilever beam including a fixed end and a free end and being connected to the upright post through the fixed end, the ribbed plates being connected between the upright post and a top surface of the cantilever beam, the main shaft being disposed at the free end of the cantilever beam, wherein the at least an electric heating piece and the cooling chip are disposed on one of a left side of the cantilever beam and a right side of the cantilever beam.

10. The machine tool capable of reducing thermal errors according to claim 6, wherein the main shaft support element includes a cantilever beam and two opposing ribbed plates, the cantilever beam including a fixed end and a free end and being connected to the upright post through the fixed end, the ribbed plates being connected between the upright post and a top surface of the cantilever beam, the main shaft being disposed at the free end of the cantilever beam, the at least an electric heating piece being in a number of two and disposed on left and right sides of the cantilever beam, respectively, and the cooling chip being in a number of two and disposed on the left and right sides of the cantilever beam, respectively.
